(19) United States
(12) Patent Application Publication
(10) Pub. No.: US 2012/0311487 A1
(43) Pub. Date: Dec. 6, 2012

(54) AUTOMATICALLY WRAPPING ZOOMED CONTENT

(76) Inventors: GEORGE ROSS STAIKOS, Toronto (CA); Eli Joshua Fidler, Toronto (CA); Margaret Elizabeth Kuo, Kitchener (CA); Adam Chester Treat, Boston, MA (US); Matthew Nicholaos Staikos, Toronto (CA); Thomas Jan Stovicek, San Francisco, CA (US)

(21) Appl. No.: 13/149,090

(22) Filed: May 31, 2011

(51) Int. Cl. G06F 3/048

(52) U.S. Cl. 715/800

(57) ABSTRACT

An electronic device receives a request to zoom content displayed in a display screen. A width corresponding to the display screen is determined. The zoomed content is wrapped to cause the zoomed content to fit within the determined width.

### BACKGROUND

Electronic devices, such as computers, personal digital assistants (PDAs), mobile telephones, and so forth, include display devices for displaying received data. Examples of data that can be received for display include web pages, electronic mail messages, and so forth.

When content is displayed in a display screen, the user can make a selection to zoom into a portion of the displayed content. In some cases, as a result of zooming into the portion of the displayed content, parts of the content can lie outside the display area of the display screen and become hidden. For example, if the zoomed content includes text, only a portion of the text remains visible after zooming. A left part or a right part, or both, of the text may fall outside the display area of the display screen. A user wishing to see the left part or right part of the text would have to use a scrolling mechanism, such as a horizontal scroll bar or touch-based scrolling, to shift the displayed content horizontally.

Some users may find having to perform horizontal scrolling after zooming displayed content annoying and inconvenient.

### BRIEF DESCRIPTION OF THE DRAWINGS

Some embodiments are described with respect to the following figures:

FIGS. 1A-1B illustrate displayed content before and after zooming, respectively, in accordance with some examples;

FIG. 2 is a block diagram of an example arrangement including an electronic device incorporating some embodiments; and

FIGS. 3 and 4 are flow diagrams of processes of zoom rendering, according to various embodiments.

### DETAILED DESCRIPTION

In an electronic device such as a computer (e.g., notebook computer, tablet computer, etc.), personal digital assistant (PDA), mobile telephone, or another device, a user can activate zooming of displayed content using one of several different mechanisms. For example, a user can select a menu command to perform the zooming. Alternatively, the zooming can be based on a predefined user touch action on a touch-sensitive display screen of the electronic device. As another alternative, the zooming can be requested using another user input device of the electronic device.

In response to zooming of displayed content, a portion of previously displayed content may fall outside the boundary of the display area of the display screen, so that such portion no longer is visible after zooming. For example, the displayed content can include text. When a user zooms into the text, a portion of the text that was previously visible may become laterally cut off. To view the remainder of the text, the user typically has to perform horizontal scrolling, such as by use of a horizontal scroll bar or by performing touch-based horizontal scrolling.

In accordance with some embodiments, auto-wrapping is performed in conjunction with zooming of displayed content under certain conditions. Auto-wrapping of displayed content refers to a feature where a portion of zoomed content that would have fallen outside the display area due to zooming is automatically moved to the next line of the display area so that the portion remains visible.

In the ensuing discussion, reference is made to auto-wrapping text in response to zooming. However, note that in alternative implementations, auto-wrapping of other types of displayed content can be performed.

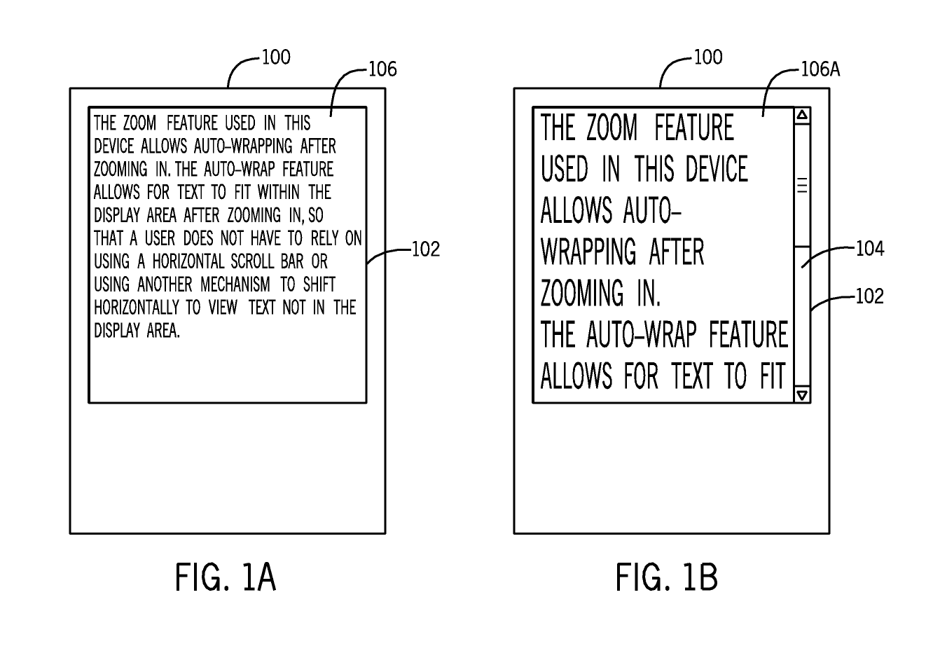

An example of auto-wrapping of text after zooming of the text is shown in FIGS. 1A and 1B. FIG. 1A depicts an electronic device 100 that has a display screen 102. Text 106 is displayed in the display screen 102.

In response to a command to zoom into the displayed text, zoomed text 106A is displayed in the display screen 102 of the electronic device 100, as shown in FIG. 1B. As a result of the zooming, the text characters have become larger. To avoid a portion of the zoomed text from being cut off in the horizontal direction, auto-wrapping is performed in response to the zooming. Thus, in the example of FIGS. 1A-1B, the words “used in this” that were in the first line of the text 106 (prior to zooming) have been moved to the second line in the zoomed text 106A, due to auto-wrapping.

In FIG. 1B, a vertical scrollbar 104 can also be shown to allow a user to scroll vertically to see additional zoomed text that is no longer in the display area due to the zooming. In other examples, the vertical scrollbar 104 is not shown, but a user can use touch-based vertical scrolling to scroll to text below that shown in FIG. 1B.

Effectively, by performing auto-wrapping in conjunction with zooming, the zoomed text has a display width that remains the same as the display width of the text prior to zooming, but the zoomed text becomes longer (in the vertical direction) than the text prior to zooming. In this manner, horizontal scrolling does not have to be performed to view text after zooming, since auto-wrapping causes the text to flow continuously within the width of the display screen 102.

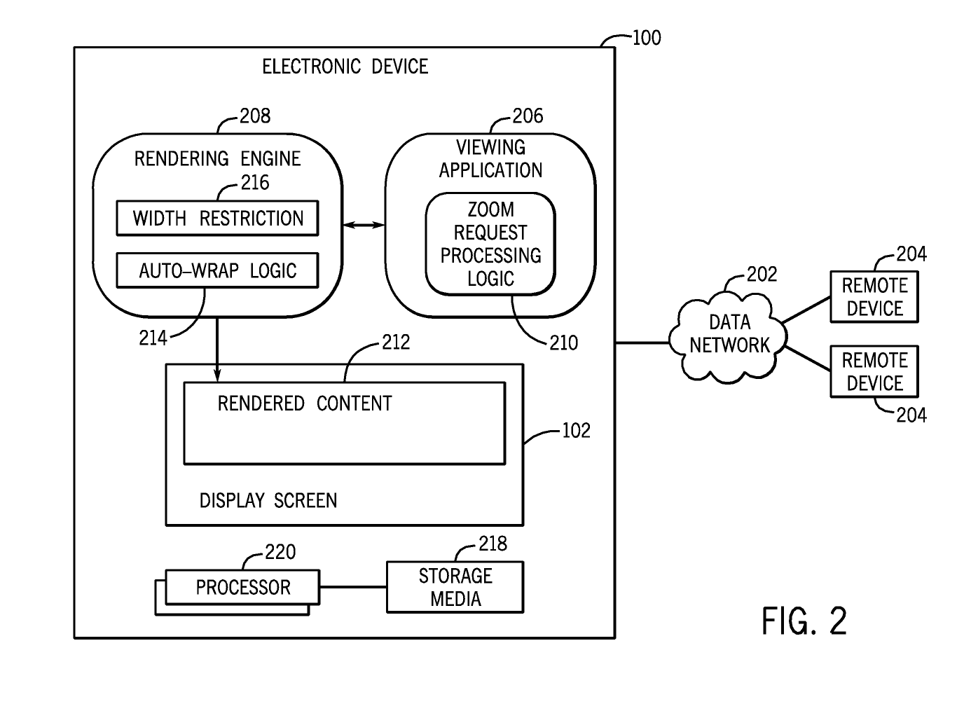

FIG. 2 illustrates an example arrangement that includes the electronic device 100. The electronic device 100 is able to communicate over a data network 202 with one or multiple remote devices 204. The remote devices 204 can include servers (such as web servers that provide websites), user devices that are able to communicate with the electronic device 100, or other types of devices.

The electronic device 100 can be connected to the data network 202 using a wired connection or a wireless connection. A remote device 204 is able to send content over the data network 202 to the electronic device 100, for display at the electronic device 100. Additionally, data to be displayed at the electronic device 100 can be generated internally at the electronic device 100, such as by a software application executing in the electronic device 100.

The electronic device 100 includes one or more processors 220 and storage media 218. A viewing application 206 is executable on the processor(s) 220. The viewing application 206 is able to receive content for display (either from a remote device 204 or from an internal source in the electronic device 100). In some examples, the viewing application 206 includes a web browser. In other examples, the viewing application 206 can be an electronic mail application to present electronic mail messages in the display screen 102, a social networking application to display social networking messages, or any other type of application that allows a user of the electronic device 100 to view rendered content 212 in the display screen 102.

The electronic device 100 also includes a rendering engine 208 (executable on the processor(s) 220) that processes content received by the viewing application 206 to allow the received content to be displayed in the display screen 102. In some implementations, the content to be displayed can be defined by a markup language such as HTML (Hypertext Markup Language). The rendering engine 208 can include a parser to parse the received content, a layout process to place different parts of the received content in a layout as the parts would appear in the display screen 102, and a painter to paint the content according to a layout specified by the layout process. In some examples, the rendering engine 208 is a WebKit rendering engine, which is an open source rendering engine used for rendering web pages. In other implementations, the rendering engine 208 can be another type of rendering engine.

The viewing application 206 includes zoom request processing logic 210 that is able to receive a zoom command from a user of the electronic device 100. The zoom command can be selection of a menu command displayed in a graphical user interface (GUI) in the display screen 202. Alternatively, the zoom command can be a touch-based zoom command, based on user touch of the touch-sensitive display screen. For example, the zoom command can be indicated by a user double-tapping on the display screen 102. Alternatively, the touch-based zoom command can be a pinch-type zoom command, such as in response to two fingers of the user performing a reverse-pinching action. Alternatively, the electronic device 100 can have another user input device, such as a trackpad or other type of user input device. User actuation of a control element (or control elements) of the trackpad or other user input device can provide an indication that zooming is requested.

In response to a zoom request, the zoom request processing logic 210 cooperates with the rendering engine 208 to zoom into a particular portion of the displayed content. In accordance with some embodiments, the rendering engine 208 has auto-wrap logic 214 that performs auto-wrapping of zoomed content.

The rendering engine 208 is programmed with a width restriction 216, which can be statically defined. The width restriction corresponds to the width of the display screen 102, and specifies a display width within which displayed content, including zoomed text, is to fit. In some examples, the width restriction 216 is equal to a width of the display screen 102 less a predefined buffer width (width of a buffer region in the display screen 102 in which rendered content is not to appear).

When performing auto-wrapping by the auto-wrap logic 214, in combination with zooming of the rendered content 212, the auto-wrap logic 214 causes the zoomed content displayed in the display screen 102 to fit within the width specified by the width restriction 216.

In some implementations, auto-wrapping is performed in response to a first type of zoom command, but not in response to a second type of zoom command. For example, auto-wrapping is performed in response to a touch-based zoom command or a zoom command entered using a trackpad. However, auto-wrapping is not performed in response to a zoom command due to another input, such as selection of a menu command. This provides flexibility to the user to perform zooming with or without auto-wrapping.

The auto-wrapping performed in conjunction with zooming is performed without having to change a container that contains the text to be rendered. According to HTML, for example, content to be rendered is placed into containers, where the containers are defined by tags in the corresponding HTML document. Certain tags of the HTML document can define text elements, and respective containers that contain the text elements. Each container is associated with a width, and the rendering engine 208 renders content contained within the container according to the width of the container. However, if auto-wrapping due to zooming were to be performed based on changing the width of the container, increased rendering engine processing can result since the layout of content around the changed container may also have to be changed.

In accordance with some embodiments, instead of changing the width of a container to perform auto-wrapping due to zooming, the container width (of the container containing the text element to be zoomed) stays unchanged, but the auto-wrap logic 214 uses the width restriction 216 specified at the rendering engine 208 to define the boundary (in the horizontal direction) within which the text element is to be wrapped—this effectively limits the width of the text element after zooming. Since the width restriction 216 corresponds to the width of the display screen 102, auto-wrapping of zoomed text to fit within this specified width allows for efficient rendering of the zoomed content to stay within the display area of the display screen in the horizontal direction.

The auto-wrapping performed according to some embodiments involves reflowing of the zoomed text. When the rendered text is zoomed, the rendered text is reflowed such that the zoomed text fits within the width specified by the width restriction 216. Reflow is the process by which bounding boxes (sometimes referred to as “inline flow boxes”) corresponding to an element (e.g. text element of an HTML document) to be rendered are computed. A bounding box can be rectangular, and is defined by a width, height, and an offset from the parent containing structure that contains the bounding box. More than one bounding box may be employed to represent a text element—for example, text that wraps is broken into several bounding boxes, one per wrapped line. In this case, a first bounding box is the bounding box containing the first line of text, with continuing bounding boxes containing subsequent lines of the wrapped text. When reflowing text in response to zooming, the bounding boxes of the zoomed text are recomputed such that the bounding boxes contains successive lines of the zoomed text while maintaining the zoomed text within the boundary of the width restriction 216.

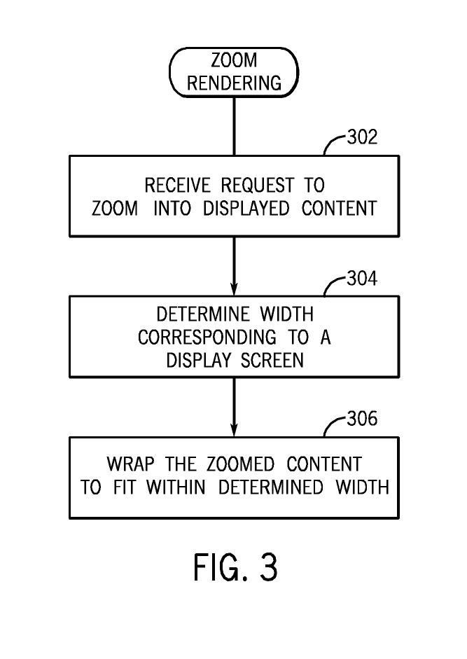

FIG. 3 is a flow diagram of a zoom rendering process according to some embodiments. The process of FIG. 3 can be performed by components of the electronic device 100 of FIG. 2, such as the zoom request processing logic 210 and the rendering engine 208. The process of FIG. 3 receives (at 302) a request to zoom into the displayed content. In response to the request to zoom, the process determines (at 304) a width corresponding to the display screen 102, where the corresponding width in some implementations is the width restriction 216 that is set at the rendering engine 208. The determining of the width can be based on reading a specified width (width restriction 216) programmed at the rendering engine 208. Alternatively, the determining can include modifying the specified width in some specified manner to derive the determined width.

Next, in response to the request to zoom, the process automatically wraps (at 306) the zoomed content to cause the zoomed content to fit within the corresponding width.

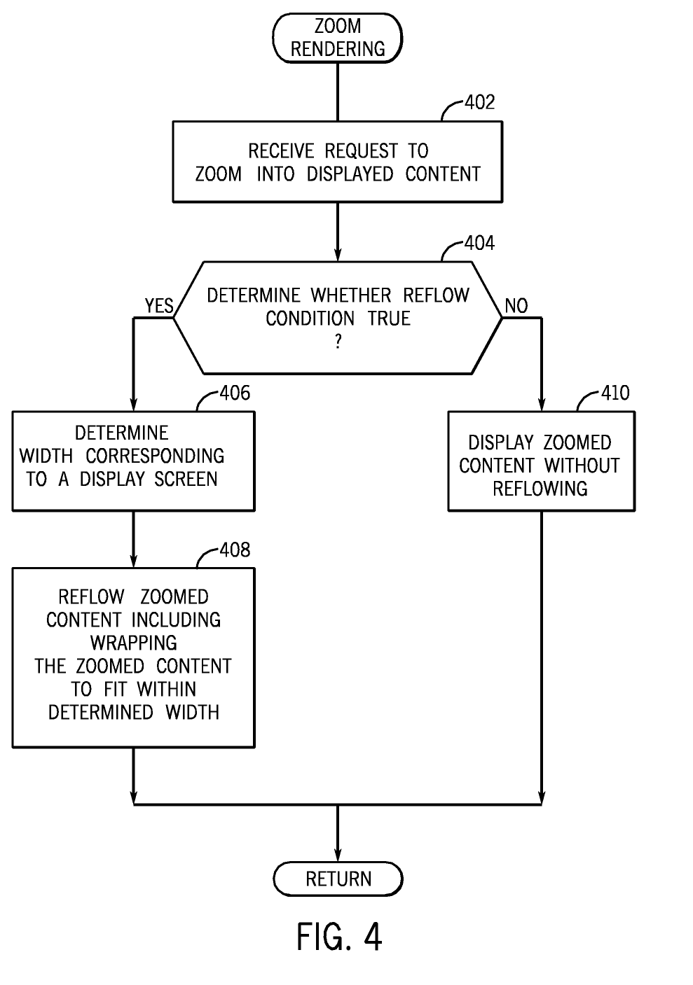

FIG. 4 is a flow diagram of a zoom rendering process according to alternative embodiments. The process of FIG. 4 receives (at 402) a request to zoom into displayed content. In response to the zoom request, the process next determines (at 404) whether a reflow condition is true—auto-wrapping is performed only if the reflow condition is true. The reflow condition can be at least one of the following. In some implementations, a programmable setting can be provided with the viewing application 206 to indicate whether or not reflow is to be performed. Programming the setting to a first state indicates that reflow is to be performed for auto-wrapping in response to zooming of displayed content. However, if the setting is programmed to a second, different state, then reflow is not performed so that auto-wrapping is not performed in response to zooming.

Another condition that is checked for by the process is whether or not the zoomed text is a fixed-position text element. A fixed-position text element is not reflowed, and thus, is not auto-wrapped in response to zooming. Another condition that is checked for by the process is whether the zoomed text is center-justified text—center-justified text is not reflowed. Moreover, text in a fixed-height container is not reflowed, except in the case of table cells, because tables can usually adjust their height even if the table height is fixed.

In response to determining that the reflow condition is true (at 404), the zoom rendering process of FIG. 4 determines (at 406) the width corresponding to the display screen 102 (e.g. the width restriction 216 of FIG. 2). The zoomed content is then reflowed (at 408), where the reflowing includes automatically wrapping the zoomed content to cause the zoomed content to fit within the corresponding width.

If the process determines (at 404) that the reflow condition is not true, then the zoomed content is displayed (at 410) without reflowing, such that no auto-wrapping of the zoomed content is performed.

By using techniques or mechanisms according to some embodiments, relatively efficient auto-wrapping of zoomed text can be provided to enhance user experience.

Machine-readable instructions of various modules described above (including 206, 208, 210, and 214 of FIG. 2) are executed on a processor or processors (such as 220 in FIG. 2). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of an electronic device, comprising:
receiving a request to zoom content displayed in a display screen of the electronic device;
zooming the content;
determining a width corresponding to the display screen;
wrapping the zoomed content based on the determined width corresponding to the display screen to fit within the determined width; and
displaying the wrapped zoomed content in the display screen.

2. The method of claim 1, wherein determining the width corresponding to the display screen comprises determining the width programmed in a rendering engine that is used to render the content for display in the display screen.

3. The method of claim 1, wherein the content displayed in the display screen corresponds to an element of input data, the method further comprising limiting a width of the element to a width based on the determined width.

4. The method of claim 1, wherein determining the width corresponding to the display screen comprises determining the width corresponding to a width of the display screen less a buffer width.

5. The method of claim 1, wherein wrapping the zoomed content is performed by a rendering engine reflowing the zoomed content, wherein reflowing the zoomed content is performed without changing a container that contains the zoomed content.

6. The method of claim 1, further comprising:
determining whether a reflow condition is satisfied,
wherein performing the wrapping is in response to determining that the reflow condition is satisfied.

7. The method of claim 6, wherein the reflow condition is at least one selected from among:
a programmable setting that specifies that reflow is to be performed in response to zooming of the content;
a determination that the content is not a fixed-position content;
a determination that the content is not center-justified content; and
a determination that the content is not contained in a fixed-height container.

8. The method of claim 6, further comprising:
receiving a second request to zoom into second content displayed in the display screen;
determining whether the reflow condition is satisfied for the second content; and
in response to determining that the reflow condition is not satisfied, displaying the zoomed second content without reflowing to fit within the specified width.

9. The method of claim 1, wherein wrapping the zoomed content comprises wrapping zoomed text to cause the zoomed text to fit within the determined width.

10. An electronic device comprising:
at least one processor;
a display screen coupled to the at least one processor;
a rendering engine executable on the at least one processor to:
in response to a request to zoom content displayed in the display screen, determine a width corresponding to the display screen; and
wrap the zoomed content based on the determined width corresponding to the display screen to fit within the determined width.

11. The electronic device of claim 10, wherein the wrapping of the zoomed content is performed without changing a width of a container containing the content, wherein the container is defined by markup language tags of an input document defining the content.

12. The electronic device of claim 11, wherein the content includes text, and wherein the rendering engine is to perform the wrapping of the zoomed text by reflowing the zoomed text.

13. The electronic device of claim 10, wherein the width corresponding to the display screen is based on a width restriction programmed into the rendering engine.

14. The electronic device of claim 10, wherein the rendering engine is to perform the wrapping of the zoomed content in response to determining that the request to zoom comprises a first type of zoom command.

15. The electronic device of claim 14, wherein the rendering engine is to further:
receive a second request comprising a second, different type of zoom command, wherein the second request is to zoom into second content displayed in the display screen; and
in response to the second request, perform zooming of the second content without performing wrapping of the zoomed second content.

16. The electronic device of claim 10, wherein the rendering engine is to wrap the zoomed content in response to a determination that a reflow condition is true, wherein the reflow condition includes at least one of the following:
a setting programmed to indicate that reflow of content is to be performed in response to zooming;
a determination that the content is not a fixed-position content;
a determination that the content is not center-justified content; and
a determination that the content is not contained in a fixed-height container.

17. An article comprising at least one machine-readable storage medium storing instructions that upon execution cause an electronic device to:
receive a request to zoom content displayed in a display screen;
zoom the content;
determine a width corresponding to the display screen;
wrap the zoomed content based on the determined width corresponding to the display screen to fit within the determined width; and
display the wrapped zoomed content in the display screen.

18. The article of claim 17, wherein wrapping the zoomed content comprises wrapping zoomed text, where the wrapping is performed by reflowing the zoomed text.

19. The article of claim 18, wherein reflowing the zoomed text to perform the wrapping is performed without changing a width of a container containing the text.

20. The article of claim 17, wherein the instructions upon execution cause the electronic device to:
determine whether a reflow condition is satisfied,
wherein performing the wrapping is in response to determining that the reflow condition is satisfied.
